(19) United States
(12) Patent Application Publication
(10) Pub. No.: US 2026/0234964 A1
(43) Pub. Date: Aug. 13, 2026

(54) LOCK

(71) Applicant: Kingsway Enterprises (UK) Limited, Sidcup (GB)

(72) Inventors: Benjamin Hall, Sidcup (GB); Nicola Zatti, Sidcup (GB)

(21) Appl. No.: 19/160,869

(22) PCT Filed: Feb. 28, 2024
(86) PCT No.: PCT/GB2024/050540

§ 371 Date: Aug. 29, 2025

(30) Foreign Application Priority Data
Mar. 1, 2023 (GB) 2303020.8

(51) Int. Cl. E05B 17/04; E05B 55/00; E05B 63/08

(52) U.S. Cl. CPC E05B 17/04; E05B 55/00; E05B 63/08

(57) ABSTRACT

The present disclosure relates to a lock for installation in a door leaf defining a first plane. The lock comprises a housing; and a bolt moveable relative to the housing between a retracted position, and an extended position in which a distal portion of the bolt protrudes from an opening in the housing. The bolt is resiliently biased into the extended position. The distal portion of the bolt comprises at least one shoulder sloped in a plane parallel to the first plane, such that the bolt is moveable into the retracted position in response to a force applied to the shoulder. The lock further comprises a first lock mechanism operable to move the bolt between the retracted and extended positions; and a second lock mechanism operable to move the bolt between the retracted and extended positions. At least one of the first and second lock mechanisms is operable independently of the other of the first and second lock mechanisms. The bolt is moveable into the retracted position independently of each of the first and second lock mechanisms.

### RELATED APPLICATION

The present application is a national stage application under 35 U.S.C. § 371 of International Application No. PCT/GB 2024/050540, filed Feb. 28, 2024, which claims priority to Great Britain Patent Application No. 2303020.8 filed Mar. 1, 2023. The above-referenced applications are hereby incorporated by reference into the present application in their entirety.

### FIELD

The present disclosure relates to a lock for a door, and in particular to a lock for use in psychiatric care settings.

### BACKGROUND

Locks for doors are widely used to ensure privacy and security. Broadly speaking, most door locks have a housing, a lock mechanism (for example, a keyed lock cylinder or thumb turn), and a bolt. A user can operate the lock mechanism which in turn moves the bolt between a locked (extended) position and an unlocked (retracted) position.

When fitted to a door that has a door leaf and a door frame, a lock as described above enables the door to be locked thus providing privacy and/or security. When locked, the bolt is received by a socket in the door frame, thus substantially preventing movement of the door leaf relative to the door frame.

The primary aim of a lock is to provide security. In order to achieve security, locks are designed to prevent the bolt from moving into the unlocked position (other than by the intended mechanism, e.g. by use of a key). Moreover, locks are designed with redundancies and backup features, all of which are specifically configured to prevent unwanted retraction of the bolt into the housing.

In psychiatric hospitals, a problem exists that patients may wish to cause themselves harm by anchoring a ligature around an available anchor point in a room. The same problem may arise in facilities other than psychiatric hospitals.

When a door having a lock as described above is locked, the bolt provides a potential anchor point around which an individual may try to secure a ligature to cause themselves harm. In particular, an individual may pass a ligature (for example, a charging cable, shoelace, or ribbon of fabric) between a gap between the door frame and the door leaf, and around the bolt. Because the bolt is received in the keep of the door frame, it provides a very stable anchor point. In short, a problem with many existing locks is that a ligature can be anchored around the bolt, thus enabling someone to cause themselves harm.

Additionally, in lower security psychiatric environments, a handle for operating the lock may be provided both on the inside of the door and on the outside of the door, such that the door can be operated both from outside the room and from inside the room. However, the ability for the inhabitant of the room to control the lock from inside of their room gives rise to a further problem. In particular, the inhabitant may force the lock from the inside of their room, thereby preventing the door from being opened from the outside. As a result, medical personnel may not be able to access the room when the patient is in danger or attempting to cause themselves harm.

GB2606214 attempts to address this problem by providing a split spindle for selectively preventing a user on one side of the door from operating the bolt of the lock. However, it is considered that the split spindle in this document provides an incomplete solution. In particular, the split spindle of this document can become jammed by deliberate and accidental misuse, thereby rendering the lock unusable. An arrangement having improved robustness is needed.

### SUMMARY

In its broadest sense, the present disclosure provides a lock having a bolt which is retractable in response to a force applied to a distal end of the bolt (for example by a ligature looped around the distal end of the bolt), and having two (further) lock mechanisms for operating the bolt, wherein at least one of the lock mechanisms is operable independently of the other of the lock mechanisms.

The present disclosure also provides a lock having a bolt which is retractable (into an unlocked position) by three independently operable means, as follows:
Application of a force to a distal end of the bolt (for example by a ligature looped around the distal end of the bolt);
Operation of the bolt by a first lock mechanism; and
Operation of the bolt by a second lock mechanism.

For example, in an aspect of the present disclosure there is provided a lock for installation in a door leaf defining a first plane, the lock comprising:
a housing; and
a bolt moveable relative to the housing between a retracted position, and an extended position in which a distal portion of the bolt protrudes from an opening in the housing;
wherein the bolt is resiliently biased into the extended position; and
wherein the distal portion of the bolt comprises at least one shoulder sloped in a plane parallel to the first plane, such that the bolt is moveable into the retracted position in response to a force applied to the shoulder;
the lock further comprising:
a first lock mechanism operable to move the bolt between the retracted and extended positions; and
a second lock mechanism operable to move the bolt between the retracted and extended positions;
wherein at least one of the first and second lock mechanisms is operable independently of the other of the first and second lock mechanisms; and
wherein the bolt is moveable into the retracted position independently of each of the first and second lock mechanisms.

Accordingly, the lock prevents ligature attempts through provision of a deadbolt which is moveable into the retracted position independently of each of the first and second lock mechanisms, and which is shaped (through provision of the at least one shoulder) to move into the retracted position in response to a force applied to the distal end of the bolt.

Additionally, barricading of a door is prevented due to at least one of the first and second lock mechanisms being operable independently of the other of the first and second lock mechanisms. In particular, a user cannot prevent access to a room by holding a first of the lock mechanisms in a locked position, because the second of the lock mechanisms remains operable, independently of the first lock mechanism, to move the bolt between the extended and retracted positions.

In summary, the lock according to the present disclosure improves safety in psychiatric care settings.

Unless described otherwise, where movement of a component of the lock is described herein, the movement is to be understood as movement relative to the housing.

Each lock mechanism may be moveable (operable) between a first position and a second position.

Movement of each lock mechanism from the first position to the second position may cause movement of the bolt from the extended position to the retracted position. In particular, when moved from the first position to the second position, each lock mechanism may engage the bolt (or a locking plate associated with the bolt) to move the bolt from the extended position to the retracted position.

Movement of each lock mechanism from the second position to the first position may cause movement of the bolt from the retracted position to the extended position. In particular, when moved from the second position to the first position, each lock mechanism may engage the bolt (or a locking plate associated with the bolt) to move the bolt from the retracted position to the extended position.

Each lock mechanism may be disengaged from the bolt (or from a locking plate associated with the bolt) when in each of the first and second positions. Accordingly, when either lock mechanism is in the first position or the second position, it is disengaged from the bolt, such that the other lock mechanism can operate to move the bolt from the extended position to the retracted position (or vice versa).

Each lock mechanism may, for example, include a first position in which it is mechanically disengaged from the bolt (or from a locking plate associated with the bolt), such that the bolt is resiliently biased into the extended (locked) position, and remains moveable into the retracted (unlocked) position, for example in response to a force applied to the distal end of the bolt. Therefore, the first lock mechanism is operable (to move the bolt between the extended and retracted positions) independently of the second lock mechanism, and vice versa.

By providing two separate lock mechanisms, at least one of which is operable independently of the other, problems encountered with prior art approaches are avoided. For example, problems associated with having a (single) lock mechanism operated by a split spindle are avoided.

Namely, a user of the first lock mechanism may be able to extend or retract the bolt regardless of which of the first or second positions the second lock mechanism is in, and a user of the second lock mechanism may similarly be able to extend or retract the bolt regardless which of the first or second positions the first lock mechanism is in. This is not possible in the split spindle approach of the prior art.

Even if a user holds the first or second lock mechanism in a given position (e.g. an unlocked position), the other lock mechanism may still be able to operate the lock (e.g. to extend the bolt). That is to say, the first lock mechanism may be able to over-ride the second lock mechanism, and vice versa.

The first lock mechanism may be operated from a first side of the housing, and the second lock mechanism may be operated from a second side of the housing, for example a second side of the housing opposite from the first side.

The first lock mechanism may comprise a cylinder lock, and may be operable by a key. The first lock mechanism may further comprise a cam surface (e.g. first cam surface) rotationally coupled to the cylinder lock, the cam surface operated by the cylinder lock. The cam surface may be arranged to operate movement of the bolt.

The second lock mechanism may comprise a thumb turn. The second lock mechanism may further comprise a cam surface (e.g. second cam surface) rotationally coupled to the thumb turn, the cam surface rotationally coupled to the thumb turn. The cam surface may be arranged to operate movement of the bolt.

The lock may further comprise a locking plate. The locking plate may be operable by each of the first and second lock mechanisms to move the bolt between the extended and retracted positions. For example, the locking plate may be moveable by each of the first and second locking mechanisms between a locked position in which the bolt is resiliently biased into the extended position, and an unlocked position in which the locking plate retains the bolt in the retracted position.

The locking plate may be separate from the bolt. The bolt may be moveable into the retracted position independently of the locking plate, e.g. when the locking plate is in the locked position.

The first lock mechanism may operate the locking plate at a first location on the locking plate. For example, a cam surface of the first lock mechanism may operate the locking plate at a first location on the locking plate.

The second lock mechanism may operate the locking plate at a second location on the locking plate which is different from the first location. For example, a cam surface of the second lock mechanism may operate the locking plate at a second location on the locking plate.

The locking plate may be moveable by each of the first and second lock mechanisms between a locked position corresponding to the extended position of the bolt, and an unlocked position in which it retains the bolt in the retracted position. Movement from the locked position to the unlocked position may cause retraction of the bolt. Movement from the second position to the first position may give rise to extension of the bolt (due to the resilient biasing of the bolt).

The bolt may be resiliently biased into the extended position by a spring, for example a leaf spring. A helical spring could, for example, alternatively be used.

The lock may further comprise a retaining plate configured to selectively retain the locking plate in each of the first and second positions. Each of the first and second lock mechanisms may be configured to disengage the retaining plate from the locking plate when operated (i.e. moved between their first and second positions), to thereby enable movement of the locking plate between the first and second positions. The retaining plate may, for example, engage castellations on the locking plate in order to retain the locking plate in each of the first and second positions.

The retaining plate may be resiliently biased into engagement with the retaining plate.

The locking plate may comprise a disengagement arm coupled thereto. The disengagement arm may be resiliently biased into a first position in which it engages the second lock mechanism such that the locking plate is operable by the second lock mechanism. The catch plate may be moveable, by the first lock mechanism, into a second, disengaged position. The disengaged position may enable a reset operation of the second lock mechanism when the second lock mechanism is out of synchronization with the bolt or locking plate.

The disengagement arm may be pivotally coupled to the locking plate. It may be biased into the first position by a spring, for example by a helical spring. However, a leaf spring could for example alternatively be used.

Where the lock is installed in a vertically oriented door leaf, the at least one shoulder may comprise an upper sloped shoulder and/or a lower sloped shoulder, for example an upper sloped shoulder and a lower sloped shoulder.

By providing a shoulder that is sloped in a plane parallel to the first plane on the distal end of the bolt, a force applied to the distal end of the bolt in a direction parallel to the first plane will cause the bolt to move from the extended position to the retracted position even if the force is applied in a direction perpendicular to the direction of movement of the bolt relative to the housing. Accordingly, whenever an individual tries to anchor a ligature around the distal portion of the bolt, the force applied to the distal portion of bolt by the ligature will cause the bolt to retract into the housing. For example, where the lock is installed in a vertically oriented door leaf, and a ligature is secured around the distal end of the bolt so as to apply a vertical (e.g. upwards or downwards) force to the distal end of the bolt, the slope of the at least one shoulder will cause the force to move the bolt into the retracted position. Accordingly, the anchor point is removed. This improves safety, by helping to prevent self-harm attempts.

The lock may be for installation in a door leaf that opens and closes in a third direction that's perpendicular to the first and second directions. The sloped at least one shoulder may form an oblique angle with each of the first and second directions, and may be perpendicular to the third direction.

In some examples, the distal portion of the bolt may further be rounded in a plane defined parallel with the first and third directions. That is, the surfaces of the bolt parallel with the first plane may also be rounded at the distal end of the bolt. This may further help with retraction of the bolt when a force as described above is applied to it.

When the bolt is in the (fully) extended position, the slope of the at least one shoulder may extend at least to the opening. The distal portion of the bolt may be rounded to form the at least one shoulder.

The at least one shoulder may comprise a first (e.g. upper) shoulder and a second (e.g. lower) shoulder opposing the first shoulder.

The lock may further comprise a shroud arranged within the housing to conceal an interior of the housing when the bolt is in the retracted position. The shroud may extend proximally from the opening. The shroud may at least partially encase the bolt.

### BRIEF DESCRIPTION OF THE DRAWINGS

Specific examples of the present disclosure will now be set out, with reference to the accompanying drawings, in which:

FIGS. 1a-1d respectively show a first, a second, a third and a fourth bolt according to the present disclosure;

FIG. 2a shows a lock according to the present disclosure, in a first (locked) configuration;

FIG. 2b shows an exploded view of the lock of FIG. 2a;

FIG. 3 shows a locking plate from the lock of FIG. 2a;

FIG. 4 shows a bolt from the lock of FIG. 2a;

FIG. 5 shows a disengagement arm for attachment to the locking plate of FIG. 3;

FIG. 6a shows a retaining plate from the lock of FIG. 2a;

FIG. 6b shows a perspective view of the retaining plate of FIG. 6a;

FIG. 7 shows the lock from FIG. 2a in a second (unlocked) configuration;

FIG. 8 shows the lock from FIG. 2a in a third (unlocked) configuration;

FIG. 9 shows the lock from FIG. 2a in a fourth (locked) configuration;

FIG. 10a shows a lock actuator according to the present disclosure in a first position;

FIG. 10b shows the lock actuator of FIG. 10a in a second position;

FIG. 10c-e show the lock actuator of FIG. 10a in respective intermediate positions, which are between the first and second positions of FIGS. 10a and 10b;

FIG. 11 shows a lock of a further example according to the present disclosure;

FIG. 12a shows a further disengagement arm from the lock of FIG. 11;

FIG. 12b shows a modified disengagement arm from the lock of FIG. 11;

FIG. 13 shows the components from FIGS. 12a and 12b attached to a locking plate;

FIG. 14 shows a modified retaining plate from the lock of FIG. 11;

FIGS. 15a-15b show respectively a front view and a rear view of a disengagement plate from the lock of FIG. 11; and

FIGS. 16a and 16b respectively show a front view and a rear view of a bolt from the lock of FIG. 11.

Like references are used for like features in the drawings.

### DETAILED DESCRIPTION

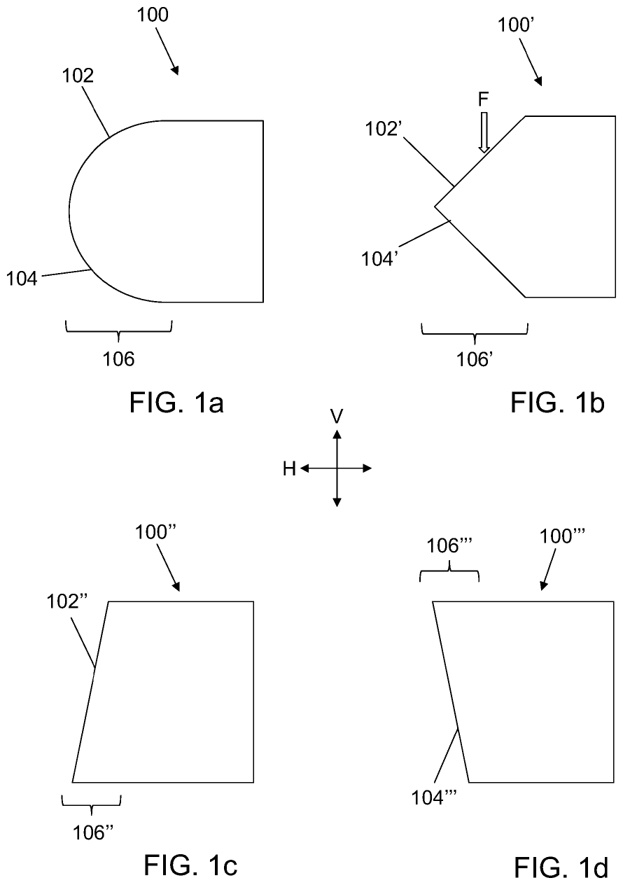

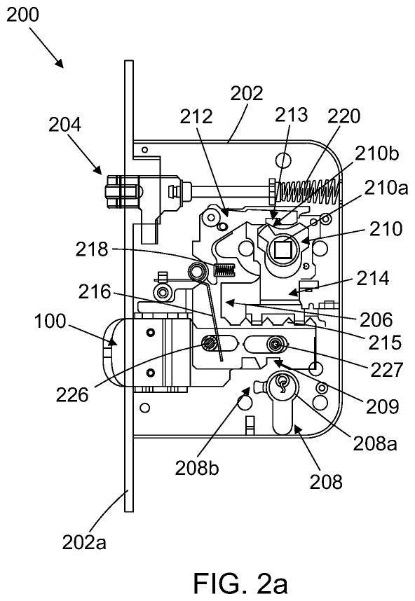

FIGS. 1a-1d show a number of example bolt configurations for use with a lock according to the present disclosure. Also shown for FIGS. 1a-1d are a first direction H, and a second direction V. For illustrative purposes, the first direction H will be described below as the horizontal direction, and the second direction V will be described below as the vertical direction. In other words, the description below is orientation-specific, in the interest of providing a clear description of a working example of the lock according to the present disclosure. However, as the reader will appreciate, the lock according to the present disclosure could in practice be used in any orientation other than that described below.

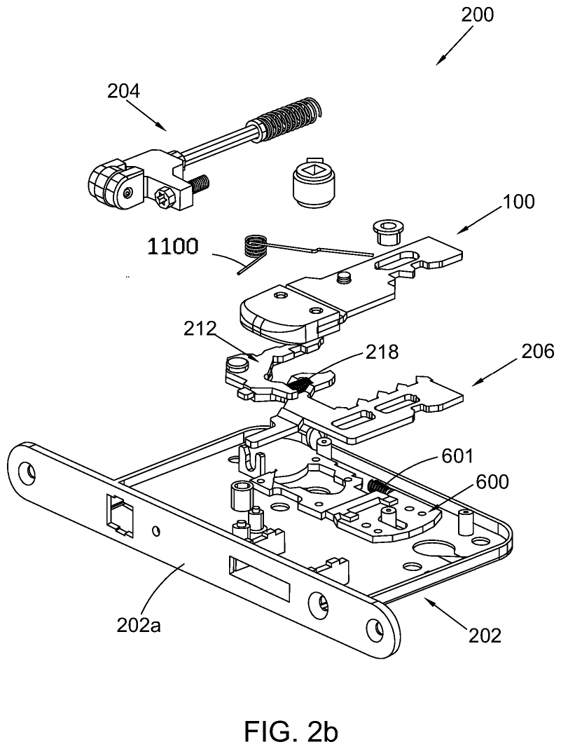

FIG. 1a shows a bolt 100 according to a first example of the present disclosure. The bolt 100 is configured for movement relative to a housing (not shown in FIG. 1) in the horizontal direction H. The distal end 106 of the bolt 100 is rounded to form a sloped upper shoulder 102, and a sloped lower shoulder 104. The distal portion 106 comprising the sloped shoulders 102, 104 is the portion of the bolt that protrudes from the housing when the bolt is in the extended (locked) position (c.f. FIG. 2a below). Each sloped shoulder forms an oblique angle with each of the vertical direction V and the horizontal direction H. Each shoulder is parallel with the plane of the page in FIG. 1a (which is parallel with the first plane of the first aspect described above).

FIG. 1b shows a bolt 100′ according to a second example. As with the bolt 100, the bolt 100′ has a distal portion 106′ which includes a sloped upper shoulder 102′ and a sloped lower shoulder 104′. Again, each of the sloped shoulders 102′, 104′ forms an oblique angle with each of the horizontal direction H and the vertical direction V.

Shown in FIG. 1b is a force F applied in a vertical (downwards) direction V to the upper sloped shoulder 102′ of the bolt 100′. Because of the slope of the shoulder 102′, where the bolt is constrained to move in the horizontal direction, the resultant force on the bolt 100′ includes a horizontal component and a vertical component. Therefore, where the bolt 100′ is constrained to move only in the horizontal direction, the force F will cause the bolt to move (retract) in the horizontal direction. As the reader will understand, the same principle applies to FIGS. 1a, 1c, 1d.

FIG. 1c shows a bolt 100″ according to a third example. The bolt 100″ also has a distal portion 106″. However, whereas the bolts 100 and 100′ include both a sloped upper shoulder and a sloped lower shoulder, the bolt 100″ includes only an upper sloped shoulder 102″. When a vertical (downwards) force F is applied to the upper sloped shoulder 102″, the bolt 100″ will similarly be caused to move in the horizonal direction.

FIG. 1d shows a bolt 100″′ according to a fourth example. The bolt 100″′ is similar to the bolt 100″ above, save for the fact that its distal portion 106″′ includes a sloped lower shoulder 104″′, rather than a sloped upper shoulder 102″.

FIGS. 2a and 2b respectively show an assembled view and an exploded view of a lock 200 according to the present disclosure in a first (locked) configuration in which the bolt 100 is in an extended (locked) position. Lock 200 includes a housing 202, which itself includes a surface plate 202a. The housing 202 contains (houses) the components of the lock 200. In use, the lock 200 may be installed in a recess along an edge of a door leaf (not shown), such that the surface plate 202a sits flush with the edge of the door leaf, and the rest of the housing 202 is concealed within the recess of the door leaf.

Surface plate 202a includes an opening (not shown in FIG. 2a) through which the distal portion 106 of the bolt 100 protrudes when the bolt 100 is in the extended position shown in FIG. 2a. Bolt 100 is resiliently biased into the extended position by a first spring 216. In particular, the bolt 100 includes an actuator pin 226. The first spring 216 engages the actuator pin 226 to bias the bolt 100 into the extended position.

In the locked configuration of FIG. 2a, the first lock mechanism 208 is in a first position, with the first lock actuator 208b disengaged from the bolt 100 and locking plate 206. Similarly, the second lock mechanism 210 is in a first position, with the second lock actuator 210b disengaged from the bolt 100 and locking plate 206.

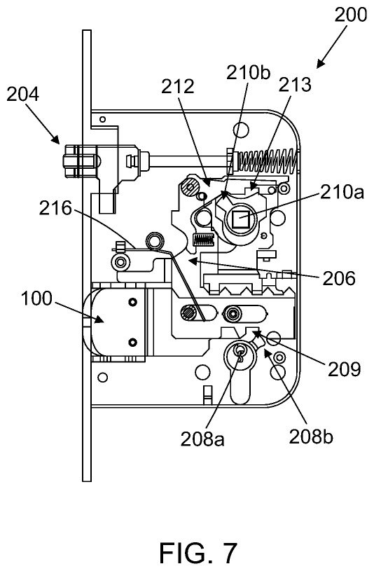

From the locked configuration shown in FIG. 2a, the bolt 100 is moveable into a retracted (unlocked) position (shown e.g. in FIG. 7), in which the distal portion 106 of the bolt 100 is retracted into the housing 202. The bolt 100 is moveable from the extended position to the retracted position by three different retraction mechanisms:

When a force is applied to the distal end 106 of the bolt 100 (for example by a ligature looped around the distal end of the bolt).

By operation of a first lock mechanism 208.

By operation of a second lock mechanism 210.

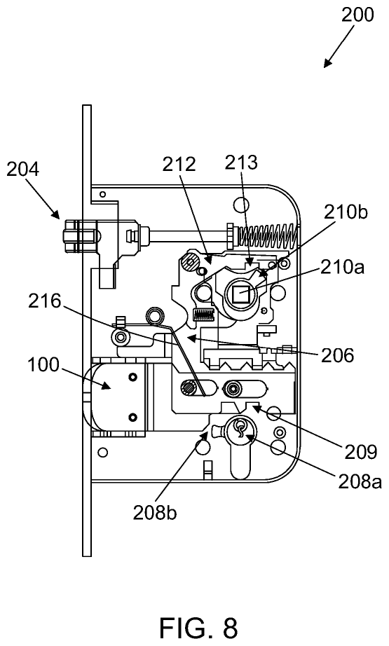

Operation of retraction mechanism 1 leads to a simple retraction of the bolt 100, independently of the locking plate 206, and against the biasing influence of the first spring 216. Operation of retraction mechanism 2 leads to the second (unlocked) configuration of FIG. 7. Operation of retraction mechanism 3 leads to the third (unlocked) configuration of FIG. 8.

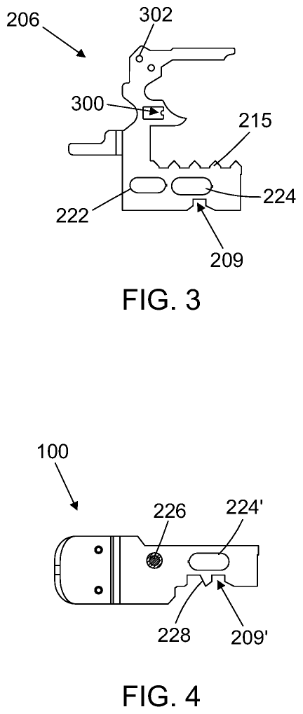

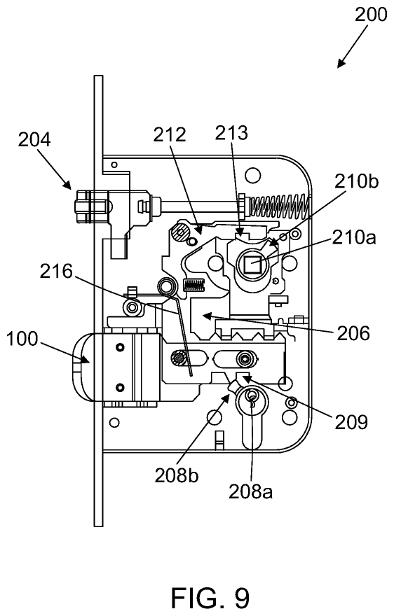

The first retraction mechanism (retraction mechanism 1 in the list above) will first be described. Retraction of the bolt is supported by a first elongate channel 222 provided in the locking plate 206 (see FIG. 3). In particular, the actuator pin 226 of the bolt 100 is received by the first elongate channel 222, and is able to move along the first elongate channel 222, from a first end of the channel 222 (as shown in FIG. 2a) to a second end of the channel 222 (as shown in FIG. 9) such that the bolt is retractable relative to (and independently of) the locking plate 206. Accordingly, when a force is applied to the distal end 106 of the bolt 100 (for example by a ligature looped around the distal end 106 of the bolt 100), the actuator pin 226 of the bolt 100 will move from the first end of the first channel 222, to the second end of the channel 222, and the bolt accordingly retracts into the housing 202, independently of the locking plate 106. The locking plate 206 remains in the locked position under this operation. When the force is removed from the distal portion 106 of the bolt 100, the bolt 100 will naturally return to the extended (locked) position under the biasing influence of the first spring 216.

The second and third retraction mechanisms from the list above will now be described.

The second and third retraction mechanisms actuate the bolt 100 via the locking plate 206. In particular, as described in further detail below, the locking plate 206 is moveable between a locked position (shown in FIG. 2a) and an unlocked position (FIG. 7 and FIG. 8), by either the first locking mechanism 208 or the second locking mechanism 210.

As described above, the locking plate 206 includes a first elongate channel 222 within which the actuator pin 226 is received. When the locking plate 206 moves from the locked position (FIG. 2a) to the unlocked position (FIG. 7), the actuator pin 226 engages the first end of the first channel 222, and moves the bolt 100 into the retracted position with the locking plate 206. That is to say, movement of the locking plate 206 from the locked position to the unlocked position causes movement of the bolt from the extended position to the retracted position.

As described below, the locking plate 206 can be operated either by the first lock mechanism 208 (second retraction mechanism listed above), or by the second lock mechanism 210 (third retraction mechanism listed above).

First lock mechanism 208 comprises a cylinder lock 208a and a corresponding first lock actuator 208b. Operation of the cylinder lock 208a (e.g. by turning of a key in the cylinder lock 208a) causes rotation of the first lock actuator 208b from the first position of FIG. 2a to a second position. When moving from the first position to the second position, the first lock actuator 208b engages a corresponding first engagement groove 209 on the locking plate 206 as shown in FIG. 7, to thereby move the locking plate 206 and the bolt 100 into the unlocked position. Once the unlocking operation is complete, the first lock actuator 208b further rotates to disengage from the first engagement groove 209 and sit in a second position.

Second lock mechanism 210 comprises a follower 210a and a corresponding second lock actuator 210b. The follower 210a is illustrated as a standard square follower. However, a splined follower could for example alternatively be used. Operation of the follower 210a (e.g. by operating a thumb turn having a square spline received within the follower) causes rotation of the second lock actuator 210b from the first position of FIG. 2a to a second position. When moving from the first position to the second position, the second lock actuator 210b engages a corresponding second engagement groove 213 as shown in FIG. 8, to thereby move the locking plate 206 and the bolt 100 into the unlocked position. Once the unlocking operation is complete, the second lock actuator 210b further rotates to disengage from the second engagement groove 213 and sit in a second position.

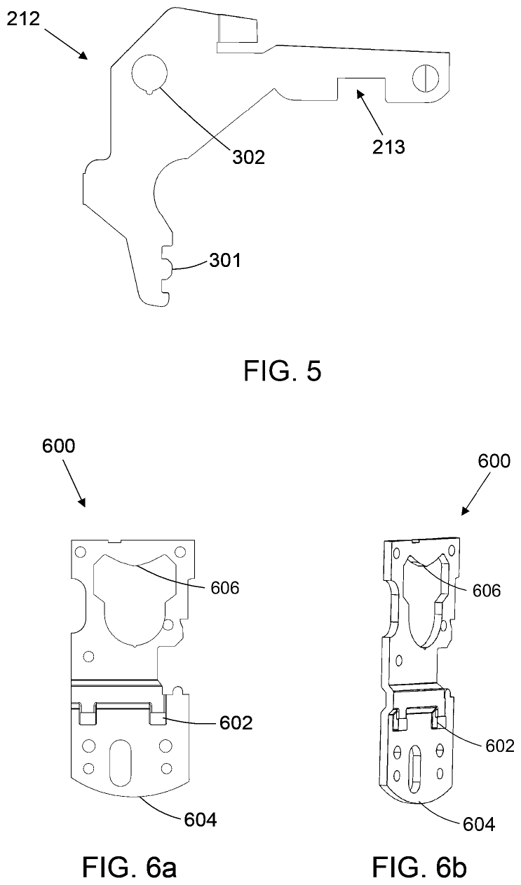

As will be described in more detail in FIG. 5 below, second engagement groove 213 is part of a disengagement arm 212 which is pivotally coupled to the locking plate 206.

As also shown in FIG. 2a, in their first positions, each of the first lock actuator 208b and the second lock actuator 210b are disengaged from their respective engagement grooves 209, 213. Accordingly, in this configuration, neither lock mechanism 208/210 obstructs or interferes with operation of the other lock mechanism 210/208 to retract the bolt. Moreover, either the first lock mechanism 208, or the second lock mechanism 210, can be used to move the bolt into the retracted position.

Returning to FIG. 2a, the lock 200 also includes a roller latch 204, which is biased into an extended position by a helical spring 220. As the reader will understand, the roller latch may in some embodiments be omitted.

FIG. 3 shows the locking plate 206 from the lock 200 of FIG. 2a. As shown, the locking plate 206 includes the first elongate channel 222 for receiving the actuator pin 226. Additionally, the locking plate 206 includes a second elongate channel 224 for receiving a guide pin 227 (shown in FIG. 2a) which extends from an inner surface of the housing 202. When the locking plate 206 moves from the locked position to the unlocked position, the second elongate channel 224 moves relative to the guide pin 227. Accordingly, the guide pin 227 restricts the movement of the locking plate 206 relative to the housing 200, such that the locking plate is moveable between the locked and unlocked positions.

Also shown in FIG. 3 is a spring engagement surface 300 for engagement by a first end of the second spring 218 (the second end of which engages the disengagement arm 212 of FIG. 5). The locking plate 206 also includes a pivot point 302 for pivotally engaging the disengagement arm 212, as will be described in further detail in relation to FIG. 5, below.

Finally, locking plate 206 includes castellations 215 for engagement by the retaining plate 600, as will be described in more detail in reference to FIG. 6, below.

FIG. 4 shows the bolt 100 according to the present disclosure. As the reader will understand, the distal end 106 of the bolt could be shaped as shown in any of FIGS. 1a-1d. The proximal portion of the bolt includes the engagement pin 226 as described above. The proximal portion also includes a first engagement groove 209′ which is arranged to coincide with the first engagement groove 209 of the locking plate 206, and is further configured to be engaged by the first lock actuator 208b for moving the bolt 100 between the locked and unlocked positions. The proximal portion of the bolt also includes an elongate channel 224′ arranged to receive the guide pin 227. Finally, the bolt 100 includes a supplementary engagement surface 228. Supplementary engagement surface is provided for engagement by the first lock actuator 208b, in the event that the first lock actuator 208b is only partially extended. That is, when the bolt 100 is only partially extended (e.g. is located between the extended and retracted positions), the first lock actuator 208b will still be able to engage the supplementary engagement surface 228 of the bolt 100 to move the bolt 100 into the retracted position.

FIG. 5 shows the disengagement arm 212 according to the present disclosure. The disengagement arm includes the second engagement groove 213, for engagement by the second lock actuator 210b. Disengagement arm 212 further includes an engagement surface 301 for engaging the second end of the second spring 218. Disengagement arm 212 includes a pivot point 302 for pivotal attachment to the locking plate 206.

FIGS. 6a and 6b respectively show a plan view and a perspective view of the retaining plate 600 according to the present disclosure. Retaining plate 600 is also visible in the exploded view of FIG. 2b. The retaining plate 600 is resiliently biased into a first position by a third spring 601. In the first position, retaining tabs 602 of the retaining plate 600 engage the castellations 215 on the locking plate 206, in order to prevent movement of the locking plate 206. However, when either the first lock mechanism 208, or the second lock mechanism 210, is moved between its first and second positions, retaining plate 600 is moved into a second, raised position, in which the retaining tabs disengage from the castellations 215 in order to enable movement of the locking plate 206 between the locked and unlocked positions.

Retaining plate 600 includes a lower engagement surface 604, and an upper engagement surface 606. When the first lock mechanism 208 is in its first position or second position, first lock actuator 208b is disengaged from the retaining plate, and the retaining plate therefore sits in the first position in which the retaining tabs 602 engage the castellations 215 and movement of the locking plate 206 is prevented. However, when the first lock mechanism 208 is moved between its first and second positions, the first lock actuator 208a engages the lower engagement surface 604 and moves the retaining plate 600 into the second position, such that the retaining plate 600 is disengaged from the locking plate 206 and the locking plate is moveable between the first and second positions.

Similarly, when the second lock mechanism 210 is in its first position or second position, second lock actuator 210b is disengaged from the retaining plate, and the retaining plate therefore sits in the first position in which the retaining tabs 602 engage the castellations 215 and movement of the locking plate 206 is prevented. However, when the second lock mechanism 210 is moved between its first and second positions, the second lock actuator 210a engages the upper engagement surface 606 and moves the retaining plate 600 into the second position, such that the retaining plate 600 is disengaged from the locking plate 206 and the locking plate is moveable between the first and second positions.

FIG. 7 shows a second (unlocked) configuration of the lock 200 according to FIG. 2a. This second (unlocked) configuration is the result of unlocking the lock by operation of the first lock mechanism 208. As shown in FIG. 7, the first lock actuator 208a has been rotated from the first position of FIG. 2a, towards a second position. In rotating to the second position, the first lock actuator 208b engages the first engagement grooves 209, 209′ in order to move the lock plate 206 and the bolt 100 into the retracted (unlocked) position. To complete the unlocking operation, the first lock mechanism 208 is operated until the first lock actuator 208b rotates clockwise to disengage from the groove 209, 209′. Accordingly, once the unlocking operation is complete, the first lock mechanism 208 no longer engages the locking plate 206. It therefore does not hinder movement of the locking plate by the second mocking mechanism 210 when in this position.

During this locking operation, the first lock actuator 208b also acts on the lower engagement surface 604 of the retaining plate 600 to thereby lift the retaining plate 600. By lifting the retaining plate, such that it disengages from the castellations 215 of the locking plate 206, the locking plate is free to move from the locked position to the unlocked position and therefore move the bolt to the retracted position. Once the first lock actuator 208b has moved the locking plate 206 and bolt 100 into the locked position, it disengages from the retaining plate 600, such that the retaining plate 600 moves back into engagement with the castellations 215 of the locking plate 206 under the influence of the third spring 601. Accordingly, even once the first lock mechanism has been fully rotated such that the first lock actuator 208b no longer engages the engagement grooves 209, 209′, the retaining plate 600 engages the castellations 215 of the locking plate 206 so as to retain the lock in the unlocked position. Moreover, because the first lock actuator 208b is able to disengage once more from the engagement grooves 209, 209′, it does not obstruct operation of the lock by the second lock mechanism 210.

While in the second (unlocked) configuration of FIG. 7, the lock 200 can be returned to the locked configuration of FIG. 2a by operation of the first lock mechanism 208, or by operation of the second lock mechanism 210. Regarding operation by the first lock mechanism 208, this is achieved by simply returning the first lock mechanism to the first position, i.e. by reversing the unlocking process as described above. When this is done, the locking plate 206 and the bolt 100 are returned to the locked position.

In order to return the lock 200 from the second (unlocked) configuration of FIG. 7 to the locked configuration of FIG. 2a using the second lock mechanism 210, a reset operation must first be performed. In particular, the second lock mechanism must first be moved from the first position, to the second position. This involves operating the thumb turn (not shown) such that the second lock actuator 210b rotates clockwise to engage the second engagement groove 213 on the disengagement arm 212. As the second lock actuator 208b moves from the first position to the second position, it lifts the disengagement arm 212 against the force of the second spring 218. The disengagement arm returns to its engaged position, under the influence of the second spring 218, once the second lock actuator 210b has reached the second position such that it can engage the second engagement groove 213 and the upper engagement surface 606 to operate the locking plate 206.

Once the reset operation has been performed as outlined above, the first locking mechanism 208 is in the second position and can engage the engagement groove 209; and the second locking mechanism 210 is in the second position and can engage the engagement groove 213. Moreover, in their second positions, the first and second locking mechanisms are disengaged from the locking plate 206. Therefore, both locking mechanisms can now operate the locking plate 206 to return the bolt to the extended (locked) position. During this operation, the locking mechanism being operated would once again lift the retaining plate 600 over the castellations 215 of the locking plate 206 such that the locking plate can return to the locked configuration.

FIG. 8 shows a third (unlocked) configuration of the lock 200 according to FIG. 2. This third (unlocked) configuration is the result of unlocking the lock by operation of the second lock mechanism 210. As shown in FIG. 8, the second lock actuator 210b has been rotated from the first position of FIG. 2a, towards the second position of FIG. 8. In rotating to the second position, the second lock actuator 210b engages the second engagement groove 213 in order to move the lock plate 206—and hence the bolt 100—into the retracted (unlocked) position. To complete the unlocking, the second lock actuator 210b is further rotated such that it disengages from the second engagement groove 213.

While performing this unlocking operation, the second lock actuator 210b also raises the retaining plate 600 such that it disengages from the castellations 215 on the locking plate 206, such that the locking plate 206 is free to move from the locked position to the unlocked position. Once the second lock actuator 210b has moved to the first position, it disengages once more from the retaining plate 600 such that the retaining plate moves back into engagement with the castellations 215 on the locking plate 206 to thereby retain the locking plate 206 in the unlocked position as shown.

The lock 200 can be moved from the third (unlocked) configuration of FIG. 8, to the first (locked) configuration of FIG. 2a by operating the second lock mechanism 210, or to the fourth (locked) configuration of FIG. 9 by operating the first lock mechanism 208. Regarding operation by the second locking mechanism 210, this simply involves reversing the operation that moved the lock 200 from the first (locked) configuration of FIG. 2a to the third (unlocked) configuration of FIG. 8. In particular, a user operates the thumb turn (not shown) in order to move the second lock actuator 210b from the second position to the first position, thereby returning the locking plate 206 and the bolt 100 to the locked position. This operation again lifts the retaining plate 600 over the castellations 215 of the locking plate 206 in order to enable movement of the locking plate back to the locked position.

Regarding operation by the first locking mechanism to move from the FIG. 8 configuration to the FIG. 9 configuration, this can be achieved by operating the cylinder lock 208a to rotate the first lock actuator 208b. In particular, the first lock actuator 208b can be caused to perform a complete counter-clockwise rotation from the position in FIG. 8, such that the second lock actuator 208b engages the first engagement groove 209 to return the locking plate 206, and therefore the bolt 100, to the locked position. The first lock actuator 208b will again lift the retaining plate 600 such that it moves over the castellations 215 of the locking plate 206 to thereby enable the movement of the locking plate 206. Accordingly, the lock 200 moves to the locked configuration shown in FIG. 9.

FIG. 9 shows a fourth (locked) configuration of the lock 200 according to FIG. 2a.

From the fourth (locked) configuration shown in FIG. 9, the lock 200 can be moved to an unlocked configuration by operation of the first lock mechanism 208, or by operation of the second lock mechanism 210. Operation by the first lock mechanism 208 is simple. In particular, a user simply operates the cylinder lock 208a in order to thereby move the first lock actuator 208b into the second position, whereby the first lock actuator 208b engages the engagement grooves 209, 209 to move the locking plate 206 and the bolt 100 into the unlocked position.

From the fourth (locked) configuration of FIG. 9, operation by the second lock mechanism 210 first requires a reset operation. In particular, the second lock actuator 210b must first be moved into the first position by operation of the thumb turn. During this operation, the disengagement arm 212 will be lifted by the second lock actuator 210b, until the second cam surface is received in the second engagement groove 210 and the disengagement arm 212 returns to its engaged position under the influence of the second spring 218. The lock 200 is then in the first (locked) position shown in FIG. 2a, such that the lock can be moved to the unlocked position as has been described above.

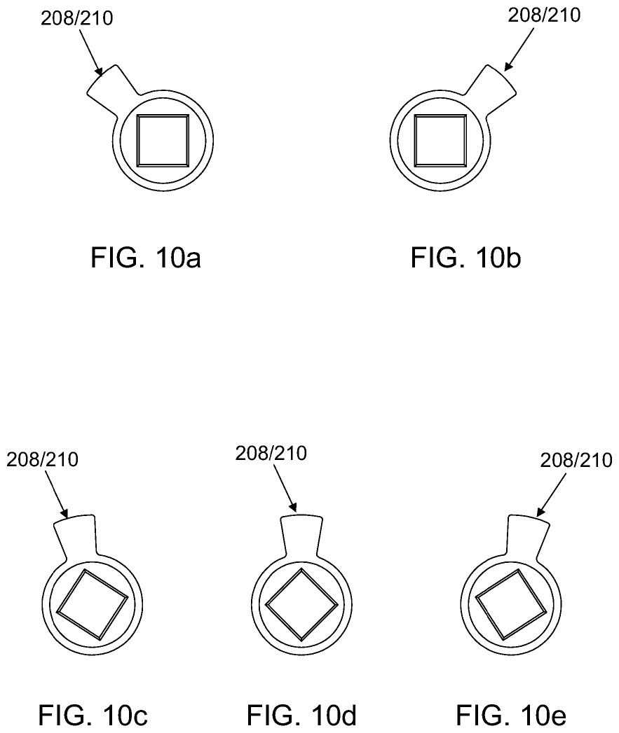

FIGS. 10a and 10b respectively show a lock actuator according to the present disclosure in a first position, and in a second position. FIGS. 10c-10e show the lock actuator in intermediate positions between the first and second positions. As the reader understands, when the lock actuator is moved from the first position to the second position, it will move through the positions of FIGS. 10c, 10d, and then 10e (or vice versa for movement from the second position to the first position). In the above description, each lock mechanism 208 and 210 have been described as having a first position and a second position. For each lock mechanism, the first position corresponds to a position in which the corresponding lock actuator (208b/210b) is in a first position as shown in FIG. 10a. For each lock mechanism, the second position corresponds to a position in which the corresponding lock actuator (208b/210b) is in a second position as shown in FIG. 10b. In each of the first position and the second position, the lock mechanisms are disengaged from the locking plate 206 and from the retaining plate 600.

When each lock mechanism is moved from the first position to the second position (or vice versa), it will move through a plurality of intermediate positions, examples of which are shown in FIGS. 10c-10e. When in the intermediate positions, the lock actuator (208b/210b) will engage the locking plate 206 and the retaining plate 600 as has been described above.

As described above, there does not exist a lock configuration in which the first lock mechanism 208 is not able to move the bolt between the locked and unlocked positions. Additionally, there does not exist a lock configuration in which the second lock mechanism is not able to move the bolt between the locked and unlocked positions. Finally, there does not exist a locked configuration in which the bolt is not free to move into the retracted position when a force is applied to the distal end thereof.

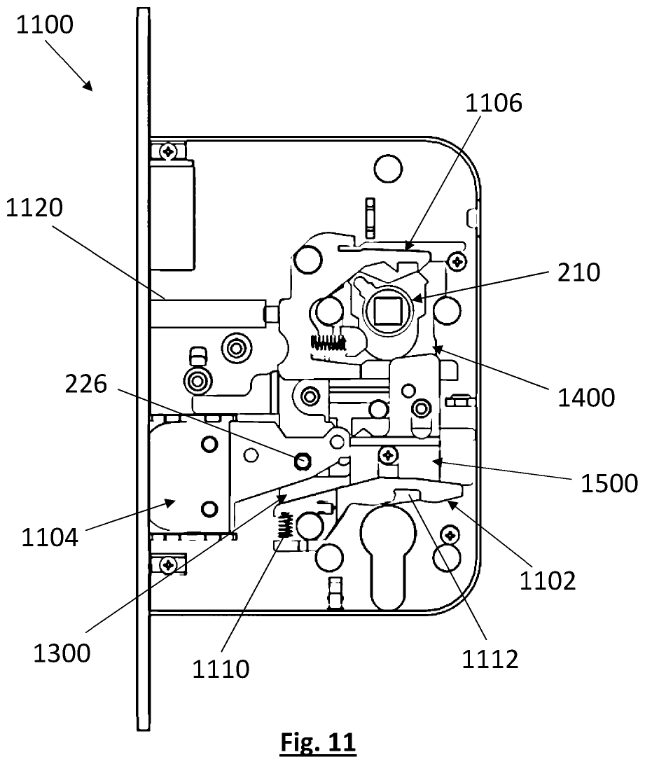

FIG. 11 shows a lock 1100 from a further example of the present disclosure. The lock 1100 is similar to the lock 200 of FIGS. 2a-2b. However, there are several differences, which are described below.

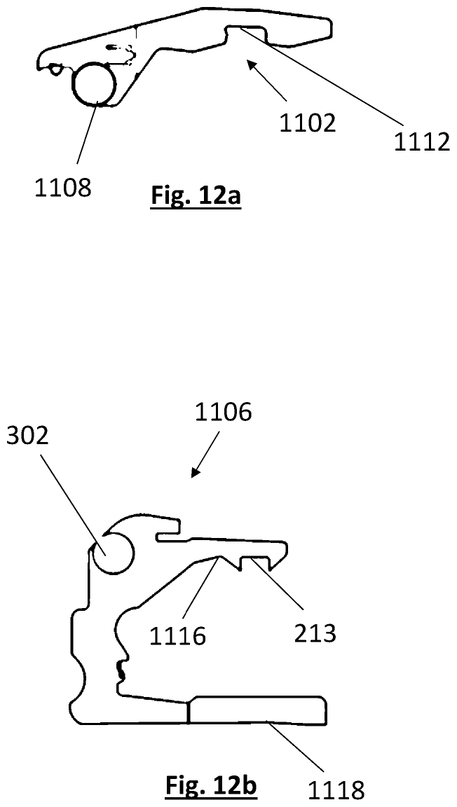

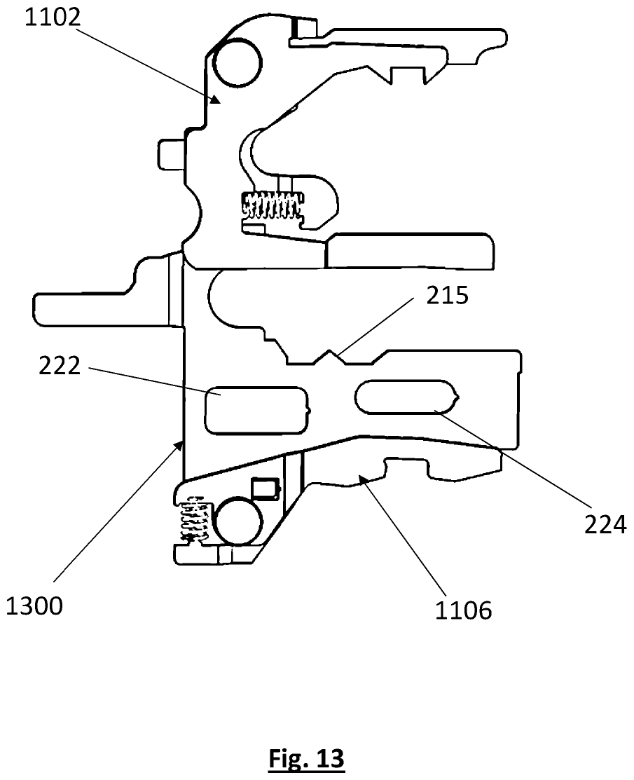

The lock 1100 of FIG. 11 includes a modified disengagement arm 1106, which differs from the disengagement arm 212. A close-up of the modified disengagement arm 1106 is provided in FIG. 12b. Additionally, the lock 1100 includes a further disengagement arm 1102, in addition to the modified disengagement arm 1106. Whereas the modified disengagement arm 1106 is operated by the second lock actuator 210b, the further disengagement arm 1102 is operated by the first lock actuator 208b. A close-up of the further disengagement arm 1102 is shown in FIG. 12a. The further disengagement arm 1102 and the modified disengagement arm 1106 are coupled to a modified locking plate 1300, as shown in FIG. 13. As shown in FIG. 13, the modified locking plate 1300 is similar to the locking plate 206. However, it includes a further attachment portion at a lower edge thereof for attachment of the further disengagement arm 1102 thereto. The locking plate 1300 may also include fewer castellations 215 than the locking plate 206, for example only one castellation 215 in the example shown.

In order to accommodate the reduced number of castellations 215 on the modified locking plate 1300, a modified retaining plate 1400 is used. The modified retaining plate 1400 is similar to the retaining plate 600. However, it only includes a single retaining tab 602.

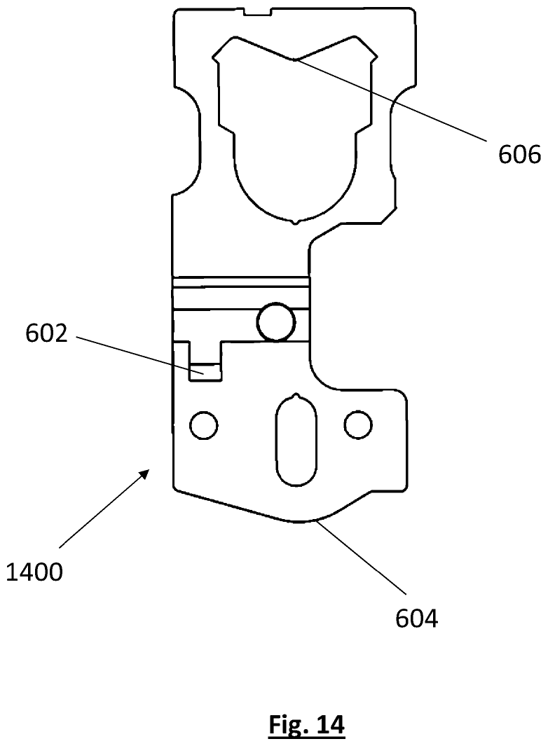

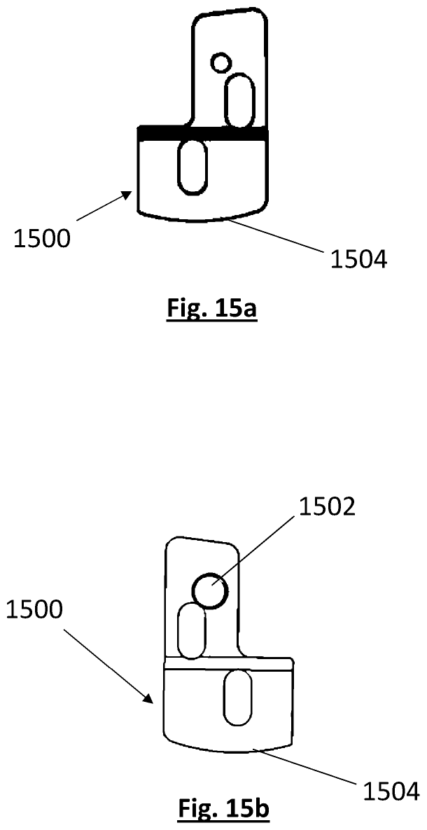

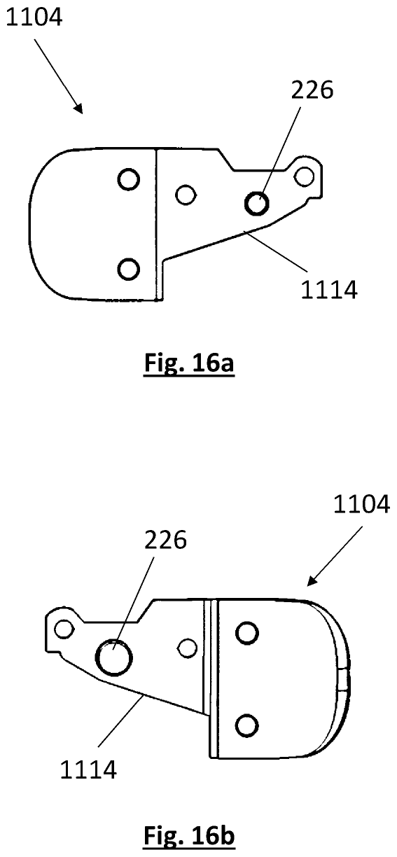

Returning to FIG. 11, a modified bolt 1104 is also used. The shape of the modified bolt 1104 is modified so that it does not interfere with the further disengagement arm 1102. A front view of the modified bolt 1104 is shown in FIG. 14a. A rear view of the modified bolt 1104 is shown in FIG. 14b. As can be seen from FIGS. 14a-14b, the actuator pin 226 extends both from the front surface of the bolt 1104 and from the rear surface of the bolt 1104. The portion extending from the front surface engages the first spring 216 (not shown in FIG. 2a). The portion extending from the rear surface engages the first elongate channel 222 of the modified locking plate 1300, such that the modified locking plate operates the bolt 1104 in the same manner as described for the lock 200.

As can also be seen from FIG. 11, the roller latch 204 is dispensed with in the lock 1100 of FIG. 11. The first spring 216 is not shown in FIG. 11. However, it is to be understood that this is just for illustrative purposes. In practice, the first spring 216 is present to resiliently bias the bolt into the extended (locked) position. Similarly, the first lock mechanism 208 is not shown in FIG. 11. However, this is again simply for illustrative purposes. In practice, the first lock mechanism 208 would be present.

Finally, a disengagement plate 1500 is present in the lock 1100. A front view of the disengagement plate 1500 is shown in FIG. 14a. A rear view of the disengagement plate 1500 is shown in FIG. 14b. The disengagement plate includes a rear protrusion 1502 which, when the disengagement plate is lifted, pushes upwards against the horizontal extension arm 1118 of the modified disengagement arm 1106, thereby disengaging the modified disengagement arm from the second lock mechanism 210. In short, the disengagement plate is operable by the first lock mechanism 208 in order to disengage the modified disengagement arm from the second lock mechanism 210. This introduces further redundancy between the first and second lock mechanisms 208, 210, thereby further improving independence between the two lock mechanisms. The first lock actuator 108b of the first lock mechanism 208 engages the lower surface 1504 of the disengagement plate 1500 in order to lift the disengagement plate 1500.

We will now describe the further disengagement arm 1102 and its function in more detail. As shown, the further disengagement arm 1102 is coupled to the locking plate 206 at a pivot point 1108. Accordingly, the further disengagement arm 1102 moves proximally and distally with the locking plate 206. Additionally, the further disengagement arm 1102 is biased into the downwards position (shown in FIG. 11) by a further spring 1110. The further disengagement arm is lifted by the first lock actuator 208b as the first lock mechanism 208 is rotated. Therefore, when the first lock actuator 208b is received within the groove 1112 of the further disengagement arm 1102, rotation of the first lock mechanism 208 in the anti-clockwise direction will move the locking plate 206 into the extended position. Similarly, when the first lock actuator 208b is received within the groove 1112 of the further disengagement arm 1102, rotation of the first lock mechanism 208 in the clockwise direction will move the locking plate 206 into the retracted position. Whenever the first lock actuator 208b is not received within the groove 1112, it can be easily moved into the groove 1112 by rotation of the first lock mechanism 208, thereby lifting the further disengagement arm 1102. The further disengagement arm 1102 will then return to its downwards position under the influence of the spring 1110, so that the first lock mechanism 208 can operate the lock 1100 via the groove 1112 of the further disengagement arm 1102. In summary, the further disengagement arm 1102 is liftable in order to temporarily disengage and thereby permit movement of the first lock mechanism 208.

The modified bolt 1104 will now be described. As shown in FIG. 12c, the distal end of the modified bolt 1104 comprises sloped shoulders for ligature protection. Additionally, the modified bolt 1104 also includes an actuator pin 226 against which the first spring 216 acts to bias the bolt into the extended position. The modified bolt 1104 differs, however, in that it includes a sloped proximal surface 1114 which is sloped so as to prevent collision with or obstruction of the further disengagement arm 1102. Although not shown in FIG. 11, the actuator pin 226 is also received within the first elongate channel 222 of the locking plate 206, such that the bolt is free to move into the extended position under the influence of the first spring 216, even when the locking plate 206 is in its retracted position. Because the proximal portion of the bolt 100 having the channel 224′ and the first engagement groove 209′ is redundant in this example, it is dispensed with. The modified bolt 1104 is therefore operated from the actuator pin 226, which itself is operated by each of the first spring 216 and the first elongate channel 222 of the locking plate 206.

Finally, the modified disengagement arm 1106 of FIG. 12b will now be described. As shown, the upper portion of the modified disengagement arm 1106 is very similar to that of the disengagement arm 212. The structure and operation thereof therefore will not be repeated here. The only slight modification to the upper portion of the modified disengagement arm 1106 is that a cutaway portion 1116 is introduced adjacent to (and distal of) the second engagement groove 213. This cutaway portion 1116 improves operation of the lock, by preventing snagging with respect to the second lock actuator 210b. A more notable change is present at the lower portion of the modified disengagement arm 1106, for engagement by the disengagement plate 1500 as described above.

In some examples, a proximally biasing spring 1120 may be provided to press proximally against the locking plate 206. The proximally biasing spring may therefore partially counteract the force of the first spring 216, thereby reducing the force required to operate either of the first lock mechanism 208 and the second lock mechanism 210. The proximally biasing spring 1120 may thereby improve smoothness of operation of the lock.

It is to be understood that the above description is intended to be illustrative, and not restrictive. Many other implementations will be apparent to those of skill in the art upon reading and understanding the above description. Although the present disclosure has been described with reference to a specific example implementation, it will be recognized that the disclosure is not limited to the implementations described, but can be practiced with modification and alteration insofar as such modification(s) and alteration(s) remain within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A lock for installation in a door leaf defining a first plane, the lock comprising:
a housing; and
a bolt moveable relative to the housing between a retracted position, and an extended position in which a distal portion of the bolt protrudes from an opening in the housing;
wherein the bolt is resiliently biased into the extended position; and
wherein the distal portion of the bolt comprises at least one shoulder sloped in a plane parallel to the first plane, such that the bolt is moveable into the retracted position in response to a force applied to the shoulder;
the lock further comprising:
a first lock mechanism operable to move the bolt between the retracted and extended positions; and
a second lock mechanism operable to move the bolt between the retracted and extended positions;
wherein at least one of the first and second lock mechanisms is operable independently of the other of the first and second lock mechanisms; and
wherein the bolt is moveable into the retracted position independently of each of the first and second lock mechanisms.

2. The lock of claim 1, wherein each of the first and second lock mechanisms is operable independently of the other of the first and second lock mechanism.

3. The lock of claim 1, wherein the first lock mechanism is operable from a first side of the housing, and the second lock mechanism is operable from a second side of the housing.

4. The lock of claim 1, further comprising a locking plate operable by the first and second lock mechanisms to move the bolt between the extended and retracted positions, wherein the locking plate is separate from the bolt, and the bolt is moveable into the retracted position independently of the locking plate.

5. The lock of claim 4, wherein the first lock mechanism operates the locking plate at a first location on the locking plate, and the second lock mechanism operates the locking plate at a second location on the locking plate which is different from the first location.

6. The lock of claim 4, wherein the locking plate is moveable by the first and second lock mechanisms between a first position corresponding to the extended position of the bolt, and a second position in which it retains the bolt in the retracted position.

7. The lock of claim 6, further comprising a retaining plate configured to selectively retain the locking plate in each of the first and second positions.

8. The lock of claim 7, wherein each of the first and second lock mechanisms is arranged to disengage the retaining plate from the locking plate when operated, to thereby move the locking plate between the first and second positions.

9. The lock according to claim 4, wherein the locking plate comprises a disengagement arm coupled thereto;
wherein the disengagement arm is resiliently biased into a first position in which it engages the second lock mechanism such that the locking plate is operable by the second lock mechanism; and
wherein the catch plate is moveable, by the second lock mechanism, into a second, disengaged position.

10. The lock of claim 9, wherein the disengagement arm is pivotally coupled to the locking plate.

11. The lock of claim 1, wherein the first lock mechanism comprises a cylinder lock.

12. The lock of claim 1, wherein the second lock mechanism comprises a thumb turn.

13. The lock of claim 1, wherein, when the bolt is in the extended position, the slope of the at least one shoulder extends at least to the opening.

14. The lock of claim 1, wherein the distal portion of the bolt is rounded to form the at least one shoulder.

15. The lock of claim 1, further comprising a shroud arranged within the housing to conceal an interior of the housing when the bolt is in the retracted position.

16. The lock of claim 15, wherein the shroud extends proximally from the opening.

17. The lock of claim 16, wherein the shroud at least partially encases the bolt.
